(19) United States
(12) Patent Application Publication
(10) Pub. No.: US 2012/0244259 A1
(43) Pub. Date: Sep. 27, 2012

(54) CELERY PACK

(75) Inventors: Robert P. GRAY, Salinas, CA (US); Dean DIEFENTHALER, Newbury Park, CA (US); William Guy MUNGER, JR., Salinas, CA (US); Manuel L. ALCALA, Oxnard, CA (US); Daniel SALDIVAR, Oxnard, CA (US); Lauri Duda BUCKLEY, Oviedo, FL (US); Lawrence K. Pierce, Aromas, CA (US)

(73) Assignee: A. DUDA & SONS, INC., Oviedo, FL (US)

(21) Appl. No.: 13/464,646

(22) Filed: May 4, 2012

Related U.S. Application Data
(63) Continuation-in-part of application No. 11/484,119, filed on Jul. 11, 2006.
Application No. 11/484,119 is a continuation-in-part of application No. 10/423,295, filed on Apr. 25, 2003, now abandoned.

(51) Int. Cl. A23L 1/212; A23L 1/025; A23L 3/3454; A23L 3/28; A23L 3/26; A23L 3/16; B65D 85/30; A23L 3/358; A23L 3/34; A23L 3/3463; A23L 3/3508; B65B 25/04; A23L 3/36

(52) U.S. Cl. 426/106; 426/392; 426/238; 426/241; 426/326; 426/248; 426/237; 426/393; 426/410; 426/395; 426/615

(57) ABSTRACT

A sanitized, ready-to-use and ready-to-eat celery pack is disclosed wherein the package consists of limbs that are from 6- to 18-inches in length and weigh from 0.10 to 11.75 pounds. The limbs are prepared by removing the butt, heart and leaves from celery stalks, cut to lengths from 6 to 18-inches, sorted by length, sanitized and packaged.

### CROSS REFERENCE TO RELATED APPLICATION

This application is a continuation-in-part of U.S. application Ser. No. 11/484,119 filed Jul. 11, 2006, which is a continuation-in-part of U.S. application Ser. No. 10/423,295 filed Apr. 25, 2003, now abandoned. Each of these references is incorporated by reference in its entirety.

### BACKGROUND OF THE INVENTION

The present invention relates to a new and distinct semi-processed celery product that is ready-to-use and/or ready-to-eat. All publications cited in this application are herein incorporated by reference.

Consuming a diet high in fruits and vegetables is associated with lower risks for numerous chronic diseases, including cancer and cardiovascular disease. In 1990, the Dietary Guidelines Committee recommended 3 or more servings of vegetables and 2 or more servings of fruit each day, and in 1991 the National Cancer Institute and the Produce for Better Health Foundation jointly established the national 5 A Day for Better Health Program. Since that time, all of the states and many national organizations have instituted programs to encourage people to increase their consumption of fruits and vegetables (Serdula, M. K., et al. 2004. Trends in Fruit and Vegetable Consumption Among Adults in the United States: Behavioral Risk Factor Surveillance System, 1994-2000. Amer. J. Pub. Health 94(6)). The national campaign to raise public awareness of the benefits of eating fruits and vegetables is leading to an increase in consumption of fruits and vegetables (ChooseMyPlate.gov Press Release, Jun. 2, 2011). New dietary guidelines suggest that fruits and vegetables should make up 50% of your plate.

Most vegetables packaged for immediate use and/or consumption by the consumer have been wounded in the preparation process, for example by cutting, tearing, or bruising from compression. Tissue damage in certain produce induces the synthesis of phenolic compounds that cause the tissue to brown. This is commonly referred to as wound-induced browning. This phenomenon reduces the quality of the fresh-cut vegetables and shortens shelf-life (see Vina, S. Z & Chaves, A. R., 2008; Loaiza-Velarde, J. G. et al., 2003). Heat-shocking the produce prior to or shortly after wounding has occurred has been found to inhibit the metabolic pathway that synthesizes the phenolic compounds, and thus effectively prevents the browning of processed and/or packaged fresh produce. This is important for commercial packaging of fresh fruits and vegetables, because it is a safe, non-toxic, and environmentally friendly way to increase the quality and shelf-life of fresh produce (see also U.S. Pat. No. 6,113,958).

Consumers demand convenience food items and this includes fresh vegetables. Whole and subdivided vegetables which, as purchased, are suitable for immediate consumption or for further processing by consumers are highly desirable. Many consumers do not want to spend time removing roots, leaves or other parts of vegetables in order to make the vegetables edible.

The present invention provides for methods and products which allow consumers to be able to eat the vegetables straight out of the package, or have them ready for use with minimum preparation.

The foregoing examples of the related art and limitations related therewith are intended to be illustrative and not exclusive. Other limitations of the related art will become apparent to those of skill in the art upon a reading of the specification.

### SUMMARY OF THE INVENTION

The following embodiments are described in conjunction with systems, tools, and methods which are meant to be exemplary and illustrative, not limiting in scope. In various embodiments, one or more of the above-described problems have been reduced or eliminated, while other embodiments are directed to other improvements.

According to the invention, in one embodiment there is provided a semi-processed packaged celery product, wherein said product is prepared by selecting said celery, preparing said celery for cutting, cutting said celery into lengths between 6 and 18 inches, sanitizing said celery, and packaging said celery.

In another embodiment, the present invention provides a sanitized ready-to-use and ready-to-eat celery product, wherein said product is ADS-2, ADS-3, ADS-4, ADS-5, ADS-7, ADS-8, ADS-11, ADS-12, ADS-13, ADS-16, ADS-17, ADS-18, ADS-19, ADS-20, ADS-21, ADS-22, ADS-23 and ADS-24.

In another embodiment, the present invention provides a sanitized ready-to-use and ready-to-eat celery product, wherein said product has had the leaves, heart, and attachment to butt removed.

In another embodiment, the present invention provides a sanitized ready-to-use and ready-to-eat celery product, wherein said product has been prepared using a thermal stress to prevent wound-induced browning.

In another embodiment, the present invention provides a method to prevent wound induced browning in a sanitized ready-to-use and ready-to-eat celery product, wherein said method comprises applying a thermal stress prior to preparation of celery for cutting.

In another embodiment, the present invention provides a method to prevent wound induced browning in a sanitized ready-to-use and ready-to-eat celery product, wherein said method comprises applying a thermal stress after the semi-processed celery product is obtained.

In another embodiment, the present invention provides a method to prevent wound induced browning in a sanitized ready-to-use and ready-to-eat celery product, wherein said method comprises applying a thermal stress simultaneously during the process of producing the semi-processed celery product.

In another embodiment, the present invention provides a method to prevent wound induced browning in a sanitized ready-to-use and ready-to-eat celery product, wherein said method comprises applying a thermal stress between two of the steps during the process of producing the semi-processed celery product.

In another embodiment, the present invention provides a method to prevent wound induced browning in a sanitized ready-to-use and ready-to-eat celery product, wherein said method comprises applying a thermal stress between approximately 40° C. and 60° C. for approximately 10 to 480 seconds.

In another embodiment, the present invention provides a method to prevent wound induced browning in a sanitized ready-to-use and ready-to-eat celery product, wherein said method comprises applying a thermal stress by immersing the celery in a liquid or exposing the celery to air.

In another embodiment, the present invention provides a method to prevent wound induced browning in a sanitized ready-to-use and ready-to-eat celery product, wherein said method comprises cooling the celery after applying a thermal stress.

In another embodiment, the present invention provides a method for cutting celery.

In another embodiment, the present invention provides a method for preparation of celery for cutting by sanitizing and removing soil, plant debris, or other physical, chemical, or microbiological contaminants from said celery.

In another embodiment, the present invention provides a method for sanitization of celery, wherein said sanitization includes a treatment using poly ethylene glycol, an oxidizing agent, bromine products, peroxyacetic acid, ozone, a thermal treatment, a non-thermal treatment, trisodium phosphate, quaternary ammonium products, acidifying agents, or enzymatic agents.

In another embodiment, the present invention provides a sanitized ready-to-use and ready-to-eat celery product, wherein said product is packaged in flexible film, rigid plastic, solid fiber, poly sleeves, plastic sleeves, poly bags, plastic bags, natural decomposable bags, or natural decomposable sleeves, and wherein said package may be opened and resealed.

In another embodiment, the present invention provides a sanitized ready-to-use and ready-to-eat celery product, wherein said product is packaged in a package comprising built-in vents or specialized pores.

In another embodiment, the present invention provides a sanitized ready-to-use and ready-to-eat celery product, wherein said product is between 6.0 and 8.0 inches long.

In another embodiment, the present invention provides a sanitized ready-to-use and ready-to-eat celery product, wherein said product is between 8.0 and 10.0 inches long.

In another embodiment, the present invention provides a sanitized ready-to-use and ready-to-eat celery product, wherein said product is between 10.0 and 12.0 inches long.

In another embodiment, the present invention provides a sanitized ready-to-use and ready-to-eat celery product, wherein said product is between 12.0 and 14.0 inches long.

In another embodiment, the present invention provides a sanitized ready-to-use and ready-to-eat celery product, wherein said product is between 14.0 and 16.0 inches long.

In another embodiment, the present invention provides a sanitized ready-to-use and ready-to-eat celery product, wherein said product is between 16.0 and 18.0 inches long.

In another embodiment, the present invention provides a sanitized ready-to-use and ready-to-eat celery product, wherein said product has a percent maximum sweetness of between 1% and 14% five to seven days after harvest compared to a whole stalk, wherein said celery limb product and said whole celery stalk are harvested on the same day.

In another embodiment, the present invention provides a sanitized ready-to-use and ready-to-eat celery product, wherein said product weighs between 0.10 and 11.75 pounds.

In another embodiment, the present invention provides a sanitized ready-to-use and ready-to-eat celery product, wherein said final celery product is between 1 and 70 limbs.

In addition to the exemplary embodiments described above, further embodiments will become apparent by reference by the study of the following descriptions.

### DETAILED DESCRIPTION OF THE INVENTION

In the description and tables which follow, a number of terms are used. In order to provide a clear and consistent understanding of the specification and claims, including the scope to be given such terms, the following definitions are provided:

### DEFINITIONS

Backcrossing. Means a process in which a breeder repeatedly crosses hybrid progeny back to one of the parents, for example, a first generation hybrid F₁ with one of the parental genotypes of the F₁ hybrid.

Blackheart. Means a lack of movement of sufficient calcium that causes the plant to turn brown and begin to decay at the growing point of the plant. Celery in certain conditions, such as warm weather, grows very rapidly and is incapable of moving sufficient amounts of calcium to the growing point.

Bolting. The premature development of a flowering stalk, and subsequent seed, before a plant produces a food crop. Bolting is typically caused by late planting when temperatures are low enough to cause vernalization of the plants.

Bolting tolerance. Means the amount of vernalization that is required for different celery varieties to bolt is genetically controlled. Varieties with increased tolerance to bolting require greater periods of vernalization in order to initiate bolting. A comparison of bolting tolerance between varieties can be measured by the length of the flowering stem under similar vernalization conditions.

Brown Stem. At or near maturity, or sometimes as a response to injury, the outer petioles will have an internal brown discoloration which is called brown stem. This is a discoloration associated with bacterial breakdown which becomes systemic. There are genetic differences for the proclivity to brown stem.

Carton Size. Carton size refers to the number of celery stalks in a carton. Celery is packaged according to size in increments of ½ dozen count. For example a 3 dozen size carton of celery contains 3 dozen stalks, and a 1½ dozen carton contains 1½ dozen stalks.

Celeriac or Root celery (Apium graveolens L. var. rapaceum). A plant that is related to celery but instead of having a thickened and succulent leaf petiole as in celery, has an enlarged hypocotyl and upper root that is the edible product.

Celery butt. The celery butt is the lower portion of the plant. It includes the basal plate, the compressed flattened stem, and a portion of the flare.

Celery heart. Means the center most interior petioles and leaves of the celery stalk. They are not only the smallest petioles in the stalk, but the youngest as well. Some varieties are considered heartless because they go right from very large petioles to only a couple of very small petioles. The heart is comprised of the petioles that are closest to the meristem of the celery stalk. Most straw and process type varieties have very little heart development.

Celery limb product. As used herein “celery limb product” means a prepared package of celery limbs prepared from one to five whole celery stalks. Celery limb product is a consumer equivalent for one to five whole celery stalks. The celery limb product is free of the portions of the celery that many customers would normally discard; such as the celery heart, leaves and butt. Celery limb products may also be characterized by a higher percentage of maximum sugars five to seven days post harvest compared to harvested whole stalk celery, where the celery limb product and the whole stalk celery are harvested on the same day.

Celery sticks. Celery sticks are small segments of the celery limb, around 3 to 5 inches in length. Generally two or more sticks are generated from a single limb and generally the joint and flare are not present in the sticks. Sticks are commonly sold in small packages as ready-to-eat and consumption is as is, i.e. for dipping. They are not a substitute for whole stalk celery.

Consumer. Consumer means the end user.

Crackstem. When the petiole cracks or splits horizontally or longitudinally. Numerous cracks in several locations along the petiole are often an indication that the variety has insufficient boron nutrition. A variety's ability to utilize boron is a physiological characteristic which is genetically controlled.

Customer. Customer means the retailer that is purchasing a product for resale (e.g. a grocery store).

Feather Leaf. At or near maturity some of the leaves generally located on the outer petioles may start to senesce and may become more yellow in color. There are genetic differences which cause feather leaf Flare. The generally wider, lower portion of the petiole next to the butt which is usually pale green or white and is approximately 1.5 to 3 inches long and having a width of 3 inches or less.

Furanocoumarins. Means one of the chemical compounds that is responsible for the characteristic flavor and aroma of celery.

Gross yield. Means the total yield in pounds per acre of whole, untrimmed celery plants.

Harvest. As used herein, “harvest” means the removal of a plant or celery from the growing area or field once the plant or celery has reached the desired size.

Heart. Refers to those petioles having the leaf intact that measure less than 40 cm from petiole base to leaf tip.

Heat-shock. Refers to a procedure wherein plant tissue is exposed to heat to prevent the synthesis of wound-induced proteins, such as phenylalanine ammonia-lyase (PAL).

High Pressure. As used as a santization treatment, high pressure refers to the application of about 60,000 PSI (pounds per square inch) to about 100,000 PSI.

Joint. The joint is at the top of the petiole where the leaves are attached. Since the leaf blades are attached at the joint with a stem it is possible to remove the leaves while leaving the joint intact.

Leaf celery or smallage (Apium graveolens L. var. secalinum). A plant that has been developed primarily for leaf and seed production. Often grown in Mediterranean climates, leaf celery more closely resembles celery's wild ancestors. The stems are small and fragile and vary from solid to hollow and the leaves are fairly small and are generally bitter. It is often used for its medicinal properties and as a spice. (This is not necessary but can stay, your choice. It is part of the straw patent but will not hurt this patent.)

Limb. The limb is the petiole excluding the leaves and the attachment to the butt. It may or may not include the flare or the joint. Celery branch is another term used to describe a celery limb. The celery limb ranges from between 6.00, 6.27, 6.43, 6.65, 6.89, 7.00, 7.24, 7.44, 7.62, 7.89, 8.00, 8.21, 8.48, 8.63, 8.87, 9.00, 9.27, 9.43, 9.65, 9.89, 10.00, 10.24, 10.44, 10.62, 10.88, 11.00, 11.21, 11.48, 11.64, 11.82, 12.00, 12.23 12.47, 12.66, 12.84, 13.00, 13.25, 13.43, 13.69, 13.86, 14.00, 14.26, 14.49, 14.63, 14.88, 15.00, 15.29, 15.47, 15.61, 15.83, 16.00, 16.28, 16.44, 16.67, 16.82, 17.00, 17.26, 17.45, 17.64, 17.88 to 18.00 inches and all integers and fractions thereof.

Maturity Date. Maturity in celery can be affected by two conditions. The first, known as true maturity, is the point in time when the celery reaches maximum size distribution, but before any defects such as pith, yellowing, Feather Leaf or Brown Stem appear. The second, known as market maturity, is an artificial maturity dictated by market conditions, i.e, the market requirement may be for 3 dozen size cartons so the field is harvested at slightly below maximum yield potential because the smaller sizes are what the customers prefer at that moment.

Packaged. Celery limbs are packaged according to length and may be packaged by any number of methods according to the specifications of the customer. The product may be packaged and sealed in flexible films, including sleeves or bags that may or may not be resealable, rigid plastic containers like clam shells, solid fiber containers, poly sleeves, plastic sleeves, poly bags, plastic bags, natural decomposable bags, natural decomposable sleeves, or any combination thereof. Variations in the packaging may include different gas exchange rates which may occur due to different permeability or transmission properties of the package materials themselves or due to vents or specialized pores built into the packaging. The package weight ranges from 0.10 to 11.75 pounds and includes all integers and fractions thereof.

Packaged celery heart. Packaged celery heart is a packaged product which contains the celery heart made from 4 to 6 dozen count celery stalks generally packaged as two or three stalks packaged in a single poly/plastic sleeve. They are generally 7 inches to 9 inches in length.

Petiole. A petiole is the stem or limb of a leaf, and is the primary portion of the celery consumed.

Percent maximum sweetness. As used herein, “percent maximum sweetness” means the levels of four sugars found in celery: glucose, fructose, sucrose and mannitol. Each type of sugar has a different sweetness level so each is converted to a sweetness equivalence value. Sucrose has a calculated sweetness equivalence value at 100, fructose 173, glucose 74 and mannitol 70. The total sweetness equivalence value was calculated by adding each sugar for each sample each day of testing. The percent maximum sweetness is calculated by identifying the peak sweetness value for the celery or 100% of the maximum sweetness for the celery products being tested. Each sample of celery is compared as a percentage of this maximum sweetness based upon the peak sweetness level. The increased percent maximum sweetness of the present invention range from 1%, 2%, 3%, 4%, 5%, 6%, 7%, 8%, 9%, 10%, 11%, 12%, 13% and 14% and including all integers and fractions thereof.

Pith. Pith is a sponginess, hollowness, and/or white discoloration that occurs in the petioles of varieties naturally as they become over-mature. In some varieties it occurs at an earlier stage causing harvest to occur prior to ideal maturity. Pith generally occurs in the outer older petioles first. If it occurs, these petioles are stripped off to make grade, thus effectively decreasing the stalk size and overall yield potential.

Phthalides. Means one of the chemical compounds that is responsible for the characteristic flavor and aroma of celery.

Plant Height. The height of the plant from the base or butt of the celery plant to the top of the tallest leaf.

Preparation of Apium graveolens celery for cutting. Includes, but is not limited to, the removal of the leaves, heart, and attachment to butt.

Product. A sanitized ready-to-use and ready-to-eat package of celery containing only the most desirable portion of the celery stalk, the celery limbs. Limb length and package weight may vary depending on the customer's specifications and variety or stalk size utilized to generate the product.

Product 6 inches in length. Product 6 inches in length means a celery product 5.5, 5.6, 5.7, 5.8, 5.9, 6.0, 6.1, 6.2, 6.3 and 6.4 inches long and all integers and fractions thereof.

Product of 7 inches in length. Product 7 inches in length means a celery product 6.5, 6.6, 6.7, 6.8, 6.9, 7.0, 7.1, 7.2, 7.3 and 7.4 inches long and all integers and fractions thereof.

Product 8 inches in length. Product 8 inches in length means a celery product 7.5, 7.6, 7.7, 7.8, 7.9, 8.0, 8.1, 8.2, 8.3 and 8.4 inches long and all integers and fractions thereof.

Product 9 inches in length. Product 9 inches in length means a celery product 8.5, 8.6, 8.7, 8.8, 8.9, 9.0, 9.1, 9.2, 9.3 and 9.4 inches long and all integers and fractions thereof.

Product 10 inches in length. Product 10 inches in length means a celery product 9.5, 9.6, 9.7, 9.8, 9.9, 10.0, 10.1, 10.2, 10.3 and 10.4 inches long and all integers and fractions thereof.

Product 11 inches in length. Product 11 inches in length means a celery product 10.5, 10.6, 10.7, 10.8, 10.9, 11.0, 11.1, 11.2, 11.3 and 11.4 inches long and all integers and fractions thereof.

Product 12 inches in length. Product 12 inches in length means a celery product 11.5, 11.6, 11.7, 11.8, 11.9, 12.0, 12.1, 12.2, 12.3 and 12.4 inches long and all integers and fractions thereof.

Product 13 inches in length. Product 13 inches in length means a celery product 12.5, 12.6, 12.7, 12.8, 12.9, 13.0, 13.1, 13.2, 13.3 and 13.4 inches long and all integers and fractions thereof.

Product 14 inches in length. Product 14 inches in length means a celery product 13.5, 13.6, 13.7, 13.8, 13.9, 14.0, 14.1, 14.2, 14.3 and 14.4 inches long and all integers and fractions thereof.

Product 15 inches in length. Product 14 inches in length means a celery product 14.5, 14.6, 14.7, 14.8, 14.9, 15.0, 15.1, 15.2, 15.3 and 15.4 inches long and all integers and fractions thereof.

Product 16 inches in length. Product 16 inches in length means a celery product 15.5, 15.6, 15.7, 15.8, 15.9, 16.0, 16.1, 16.2, 16.3 and 16.4 inches long and all integers and fractions thereof.

Product 17 inches in length. Product 17 inches in length means a celery product 16.5, 16.6, 16.7, 16.8, 16.9, 17.0, 17.1, 17.2, 17.3 and 17.4 inches long and all integers and fractions thereof.

Product 18 inches in length. Product 18 inches in length means a celery product 17.5, 17.6, 17.7, 17.8, 17.9, 18.0, 18.1, 18.2, 18.3 and 18.4 inches long and all integers and fractions thereof.

Ready-to-eat product. The product has been trimmed to remove the less desirable parts, such as the leaves and butt, then cut into convenient edible format or proportions, sanitized and packaged in a clean and relatively aseptic environment. The final product is considered ready-to-eat out of the package even if not so labeled.

Ready-to-use. The product is sanitized and made ready so the consumer need only to remove it from the package and, depending on the desired use or recipe, chop, cut or slice it. No cleaning or separation of different parts of the celery stalk is required. The final product is considered ready-to-use regardless of whether or not it is so labeled on the packaging.

Ribbing. The texture of the surface of the celery petiole can vary from smooth to ribby depending on the variety. Ribbing is the presence of numerous ridges that run vertically along the petioles of the celery plant.

Sanitized. Sanitized means washed, sprayed or immersed in water and, or solution to remove soil, plant debris or other physical, chemical, microbial or fungal contaminants from the plant or limb surfaces. A sanitizing solution or process utilizing one or more sanitization treatments is utilized in one or more stages of the sanitization process.

Sanitization Treatment. The sanitization treatment may involve a sanitizing solution containing an oxidizing agent such as chlorine (including chlorine gas, sodium or calcium hypochlorite, chlorine dioxide, and acidified sodium chlorite), bromine products (such as sodium hypobromine), peroxyacetic acid, or ozone. Alternatively the product could be sanitized via thermal (steam, ultraheat treatments, surface pasteurization) or nonthermal (ultraviolet, high pressure and irradiation) treatments. Other treatment alternatives may include trisodium phosphate or quaternary ammonium products or acidifying agents or enzymatic agents.

Semi-processed celery product. A semi-processed celery product has had minimal preparation so that it retains the natural limb appearance characteristic of celery. It has been washed to remove most of the dirt, debris, insects and other inert objects or materials not desirable on a consumed product, and sanitized to kill and/or cleanse from bacterial, fungal and other microbial contaminants. This product is produced using Good Food Safety Practices and may be ‘Ready to Eat’ or ‘Ready to Use’ right out of the package even if it is not so labelled on the package.

Stalk. An entire celery plant with multiple petioles having some foliage and the butt intact, but has the roots removed.

Stringiness. Means a physiological characteristic that is generally associated with strings that get stuck between the consumer's teeth. There are two sources of strings in celery, one is the vascular bundle which can be fairly elastic and behave as a string; the second is a strip of particularly strong epidermis which is located on the surface of the ridges of the celery varieties that have ribs.

Suckers. Auxiliary shoots that form at the base of the stalk or within the auxiliary buds between each petiole. If these shoots form between the petioles of the stalk, several petioles have to be stripped off causing the celery to become smaller and the functional yields to be decreased.

Sweetness Equivalence. Sweetness is based on the concentration in a celery of the four primary types of sugar that are actively involved in the flavor profile for celery and each has its own characteristic contribution to the overall sweetness of the celery. For instance fructose, which is commonly found in celery, has a sweetness equivalent of 173 (Relative Sweetness Scale) while glucose has a sweetness rating of 74, mannitol has a rating of 70 and sucrose has a rating of 100. Each variety may have a different ratio of each of these sugars, hence a different sweetness contribution.

Thermal stress. Refers to a procedure wherein plant tissue is exposed to heat for a period of time, for example between approximately 40° C. and 60° C. for approximately 10 to 480 seconds.

Top leaves. Top leaves are those leaves that are located at the top of the stalk. These are distinguished from the leaves of the heart which are located within the stalk.

Ultra heat. Treatment that involves a rapid elevation of temperature to disinfect the surface of the product followed by a very rapid drop in temperature in order to preserve organoleptic quality of the product. Temperatures may vary depending on the product, particular contaminant organisms being destroyed and the quality of the product desired. The temperature is generally less than that of steam and higher than that often associated with pasteurization, but this may be considered surface pasteurization.

Vascular bundle. Means the xylem and phloem that run vertically through the petiole near the epidermis in groups or traces called vascular bundles.

Wound-induced browning. Process whereby wounding (for example, by cutting, cracking or breaking) of celery activates a metabolic pathway responsible for increased production of phenolic compounds that create brown pigments in plant tissue.

The present invention is a ready-to-use and ready-to-eat, sanitized celery product consisting of celery limbs in a sealed package. All limbs in a single package of the present invention are the same length, but package lengths offered may vary depending on the customer's preference. The present invention is an important replacement for whole stalk celery. The present invention embodies both a product of the whole stalk minus the less desirable portions of whole stalk celery (i.e. leaf, heart, butt) and a method for making the same.

By offering different lengths or package weights to the customer, the customer is best able to purchase a product that fits the particular demands of their particular consumer base. For example a retailer that services a convenience store consumer base may prefer to have a smaller product because its particular consumers are buying smaller portions for a single meal or recipe. A larger retail customer may prefer a larger product package that represents a 2-dozen count size celery stalk because its consumers are purchasing groceries to last a week of food preparation and meals for larger families.

By eliminating the heart, foliage, butt of the plant and, depending on the customer, a portion or all of the flare, the present invention not only is an improved product but also the weight of the present invention is unexpectedly and significantly reduced compared to the original stalks from which it was generated. This provides an additional advantage of reducing shipment costs. This is particularly critical as shipping costs escalate due to increasing fuel costs, especially when shipping product from coast to coast.

Table 1 represents the percentage of the original celery stalk, by weight, for each variety that is considered waste (leaves, butt and heart) and is removed when the stalk is prepared for 8 and 14 inch limbs. It also represents the percentage of total weight that is not shipped and the amount of overall reduction in freight. H.S.=Hill's Special.

TABLE 1
Percent Reduction of Weight

| | 8-inch | 14-inch |
|---|---|---|
| Sonora | 41% | NA |
| H.S. | 42% | NA |
| ADS-2 | 47% | NA |
| ADS-8 | 42% | NA |
| ADS-12 | 42% | 16% |
| ADS-5 | 40% | 59% |
| ADS-16 | 34% | 21% |
| ADS-3 | 38% | 55% |
| ADS-4 | 37% | 16% |
| ADS-11 | 25% | 19% |
| ADS-13 | 34% | 43% |
| ADS-17 | 22% | 13% |
| ADS-18 | 24% | 26% |

By creating a product which includes only the most desirable portion of the celery stalk, the limbs, the product volume is significantly reduced. This is also very beneficial to the consumer because there is less space utilized in the refrigerator for storage. It is also beneficial to the customer (the retail or wholesale store owner) because it takes up less space on the produce display in the store and reduces cost. Surprisingly, a reduced area for display also allows the customer to provide more product options in the refrigerated display case providing a greater diversity of healthy produce for the consumer to choose from.

By creating a product which includes only the most desirable portion of the celery stalk that is ready-to-use by the consumer, less input is required to prepare the product for consumption or recipes. This is beneficial to the consumer because there is less waste, less time involved in preparation for consumption and a greater likelihood that the consumer will utilize the entire product. By improving the likelihood that the product will be utilized, the dietary intake of the consumer is improved.

By removing the leaves and the growing point from the celery, unexpectedly the quality of this finished product is improved. Even under conditions of refrigeration, a celery stalk containing the growing point, which is a part of the heart and exists at the center of the butt, is still a living organism. When cut or injured a celery stalk begins translocating its nutritional reserves and sugars from the outside limbs to the growing point; see Zamski, et al. 2001, Analysis of celery (Apium graveolens) mannitol dehydrogenase (Mtd) promoter regulation in Arabidopsis suggests roles for MTD in key environmental and metabolic responses. Plant Mol. Biol. 47:621-631, and Noiraud, N. et al. 2000, The Sucrose Transporter of Celery. Identification and Expression During Salt Stress. Plant Phys. 122:1447-1455. While under refrigeration this process is slowed but it does not completely stop. By removing the butt, heart and leaves there is nowhere for these reserves to be translocated and the quality of the preferred portion of the celery stalk for consumption is unexpectedly sweeter and remains sweeter for a longer period of time.

### EXAMPLES

### Example 1

### Process of Generating 6- to -18 inch Limbs Using the Method of the Present Invention

Prior to the present invention, celery products available were whole celery stalks or celery sticks. Whole celery stalks include the butt, heart and leaves. Celery sticks are 3-5 inches long and are often packaged with other vegetables into party trays. The number of 4-inch sticks that can be obtained from a celery stalk depends on the number of limbs in that stalk and the length of the limbs in that stalk. Table 2 shows the average and range of number of limbs and the average and range of number of 4-inch sticks generated from different celery varieties.

TABLE 2
Average and Range of Limbs & Sticks

| Variety | | No. Limbs | No. 4-inch Sticks |
|---|---|---|---|
| Hill's Special | Average | 9.1 | 16.2 |
| | Range | 8-10 | 13-18 |
| Sonora | Average | 10.3 | 17.9 |
| | Range | 8-12 | 11-22 |
| ADS-12 | Average | 11.1 | 23.5 |
| | Range | 9-14 | 18-27 |
| ADS-5 | Average | 10.1 | 16.0 |
| | Range | 8-11 | 13-18 |
| ADS-16 | Average | 12.5 | 30.4 |
| | Range | 11-14 | 25-36 |
| ADS-11 | Average | 10.4 | 26.7 |
| | Range | 8-13 | 19-40 |
| ADS-4 | Average | 10.8 | 32.6 |
| | Range | 10-14 | 21-42 |
| ADS-13 | Average | 13.3 | 33.6 |
| | Range | 11-18 | 25-50 |
| ADS-17 | Average | 12.8 | 43.4 |
| | Range | 10-14 | 32-53 |
| ADS-18 | Average | 10.7 | 31.6 |
| | Range | 9-12 | 29-45 |
| ADS-3 | Average | 12.9 | 24.3 |
| | Range | 11-15 | 20-29 |
| ADS-21 | Average | 11.1 | 34.7 |
| | Range | 10-12 | 29-40 |
| ADS-25 | Average | 10.2 | 28.0 |
| | Range | 8-13 | 23-32 |
| ADS-26 | Average | 10.7 | 36.3 |
| | Range | 9-14 | 29-44 |

According to the method of the present invention, a whole celery stalk is trimmed to meet the customer's length specification while simultaneously removing the butt and foliage. Limbs meeting the specifications may be sorted and packaged. Joints may or may not be present depending on the desired length of the limbs. For example, taller varieties may be able to generate 14-inch limbs without a joint while the joint is more likely to be present in shorter varieties. Before being packaged, limbs are sanitized so that they are ready-to-use and ready-to-eat when received by the consumer. The stalk is trimmed by any number of procedures which include, but are not limited to, cutting by knives, razor sharp blades, saws, water jets, lasers and sound waves.

In the method of the present invention, a whole celery stalk is trimmed to remove the butt and foliage. The remaining limbs may then be trimmed to meet the customer's specifications for length and sorted and packaged. Joints may or may not be present depending on the desired length of the limbs. For example, taller varieties may be able to generate 18-inch limbs without a joint while the joint is more likely to be present in shorter varieties. Before being packaged, limbs are sanitized so that they are ready-to-use and ready-to-eat when received by the consumer. The stalk and limbs may be trimmed by any number of procedures which include, but are not limited to, the following: cutting by knives, razor sharp blades, saws, water jets, lasers and sound waves. See, for example, U.S. Pat. Nos. 3,974,725, 4,601,156, 4,753,808, 6,308,600, 4,751,094, and 5,916,354.

Limbs may be sanitized by any number of sanitization treatments which include but are not limited to, a sanitizing solution containing an oxidizing agent such as chlorine (including chlorine gas, sodium or calcium hypochlorite, chlorine dioxide, and acidified sodium chlorite), bromine products (such as sodium hypobromine), peroxyacetic acid, or ozone. Alternatively the product could be sanitized via thermal (steam, ultraheat treatments, surface pasteurization) or nonthermal (ultraviolet, high pressure and irradiation) treatments. Other treatment alternatives may include trisodium phosphate or quaternary ammonium products or acidifying agents or enzymatic agents. See, for example, U.S. Pat. Nos. 5,945,146 and 4,753,808 and U.S Publication No. 2004/0191382, Zagory, D. 1999. Sanitation Concerns in the Fresh-cut Fruit and Vegetable Industry. Paper presented at the University of California, Davis, Food Processors Sanitation Workshop, Feb. 3 and 4, 1999. Modesto, Calif., a copy of which can be found at www.davisfreshtech.com/articles_freshcut.html; Suslow, T. Chlorination in the Production and Postharvest Handling of Fresh Fruits and Vegetables, University of California, Davis, a copy of which can be found at http://ucce.ucdavis.edu/files/filelibrary/5453/4369. pdf; Liao, C., Cooke, P.H. 2001. Response to Trisodium Phosphate Treatment of Salmonella Chester Attached to Fresh-Cut Green Pepper Slices. Canadian J. Micro. 47:25-32; Jongen, W., ed. 2005. Improving the Safety of Fresh Fruit and Vegetables. C.H.I.P.S., Weimar, Tex.

Different sanitization treatments have different efficacies at different temperatures with some performing better at warmer temperatures. It has also been shown that removal of some microbiological organisms is more efficiently performed with warmer water or solutions. While it is generally considered that a disruption of the cold chain in processing is not beneficial to the product shelf life of semi-processed produce short duration heat steps that improves the efficacy of sanitization treatments and overall reduction of microbiological organisms are beneficial if followed by immediate and very rapid cooling to return the product to a core temperature slightly above 0° C. Equipment manufacturers are designing equipment that facilitates these rapid temperature changes to improve control of microbiological organisms. See, for example, U.S. Pat. Nos. 4,808,420 and 4,919,948 and 8,082,840 B2. The effects of Temperature on Sodium Hypochlorite Short-term Stability, Pulp Dissolution Capacity, and Antimicropbial Efficacy, J. of Endodontics. 31(9):669-671; Sirtes, G., Waltimo, T., Schaetzle, M., Zehinder, M. 2005. A Comparison of the Bactericidal Efficacy of 18 Disinfectants Used In The Food Industry Against Escherichia coli O157:H7 and Pseudomonas aeruginosa At 10 and 20° C. J. Applied Microbiology, 87:718-725. Tayor, J., Rogers, S., Holah, J. 1999. Stability of Electrolyzed Oxidizing Water and Its Efficacy Against Cell Suspension of Salmonella typhimurium and Listeria monocytogenes. J. of Food Protection, 66(8); 1379-1384. Fabrizio, K., Cutter, C. 2003.

With the method of the present invention, once limbs are sanitized they are packaged according to length and may be packaged in any number of methods according to the specifications of the customer. During the packaging process, the heart is removed. The heart is identified by the presence of leaves or a paler color (than that of the outer petioles) often associated with the heart that is not acceptable. The product of the present invention may be packaged in numerous types of packages including but not limited to riged plastic, flexible film, solid fiber packages or any combination thereof. Variations in the packaging may include different gas exchange rates which may occur due to different permeability or transmission properties of the package materials themselves or due to vents or specialized pores built into the packaging. The packaging may also include treatments on the inside surface of the packaging which modify gas expression, emission, or absorb gasses or products like ethylene. The packaging may also contain moisture packs or desiccant packs to modify moisture levels within the package. See for example, U.S. Pat. Nos. 4,753,808, and 4,586,313.

The present invention may or may not be packaged with modified atmospheric conditions within the package, i.e. gaseous nitrogen may be utilized to displace the oxygen in the package to improve shelf stability.

### Example 2

### Limb Lengths Generated Using the Method of the Present Invention

All limbs generated by the method of the present invention are the same length, but limb lengths offered may vary depending on the customer's preference. The 6-inch limb product results from the production of limbs from either celery hearts, which are generally 9 inches in length, or from the shortest celery acceptable in the “United States Standards for Grades of Celery” (U.S. Extra No. 1 (minimum average 7-inch joint) or U.S. No. 1 (minimum average 6-inch joint)). When a 7-inch average length celery or a 9-inch celery heart is trimmed to remove the butt and a portion of the flare and a clean sanitized cut of the upper portion of the limb is made, what remains is a 6-inch to 7-inch limb.

The 14-inch limb product of the present invention is desirable because consumers currently accept 14 inches as a standard for whole stalk celery. Some customers prefer a limb product that is still longer, 18 inches. Only a few commercially available celery varieties are long enough to allow for the creation of 14 to 18-inch limbs. Several varieties proprietary to the applicant (ADS-3, U.S. Pat. No. 7,309,821, ADS-11, U.S. Pat. No. 7,351,887, ADS-12, U.S. Pat. No. 7,249,694, ADS-13, U.S. Pat. No. 7,435,882, ADS-16, U.S. Pat. No. 7,968,774, ADS-17, U.S. Pat. No. 7,994,401, ADS-18, U.S. Pat. No. 7,964,779, ADS-21, U.S. Ser. No. 13/084,314, ADS-25 and ADS-26) are long enough to allow the creation of such limbs.

Celery limbs between 6 inches and 14 inches are also within the scope of the present invention since many celery varieties have different length to joint and subsequently different length to leaf blade attachment. Further, different varieties responses are unique under different production conditions and environments, so the length of the limb able to be packaged may vary. Table 3 shows the average joint length and range of joint lengths in inches of petioles from butt to joint for several commercial celery varieties grown under similar conditions.

TABLE 3
Celery Joint Average & Range Length

| Variety | Joint Length | Joint Range |
|---|---|---|
| Sonora | 12.2 | 11-13 |
| Hill's Special | 13.1 | 12-14 |
| ADS-2 | 10.6 | 10-11 |
| ADS-8 | 10.1 | 10-11 |
| ADS-12 | 14.4 | 14-16 |
| ADS-5 | 12.5 | 12-15 |
| ADS-16 | 16.6 | 15-18 |
| ADS-3 | 15.1 | 13-16 |
| ADS-4 | 19.4 | 18-21 |
| ADS-11 | 19.8 | 19-21 |
| ADS-13 | 17.8 | 16-19 |
| ADS-17 | 21.9 | 20-24 |
| ADS-18 | 20.6 | 19-22 |
| ADS-1 | 10.7 | 9-11 |
| ADS-7 | 10.3 | 10-11 |
| ADS-20 | 13.7 | 13-15 |
| ADS-21 | 20.3 | 18-22 |
| ADS-22 | 9.6 | 8-11 |
| ADS-23 | 13.0 | 12-15 |
| ADS-25 | 18.7 | 16-21 |
| ADS-26 | 19.7 | 19-21 |

### Example 3

### Number of Limbs Generated by the Method of the Present Invention

The number of limbs that meet the specifications of the present invention obtainable from a stalk of celery will vary depending on the size of the stalk, the variety, the maturity and the production conditions. This applicant has demonstrated in previous patent applications (ADS-1, U.S. Pat. No. 6,822,143, ADS-2, U.S. Pat. No. 7,365,248, ADS-8, U.S. Pat. No. 6,812,385, ADS-7, U.S. Pat. No. 6,818,810, ADS-3, U.S. Pat. No. 7,309,914, ADS-4, U.S. Pat. No. 7,057,099, ADS-5, U.S. Pat. No. 6,967,266, ADS-11, U.S. Pat. No. 7,351,887, ADS-12, U.S. Pat. No. 7,249,694, ADS-13, U.S. Pat. No. 7,435,882, ADS-16, U.S. Pat. No. 7,968,774, ADS-17, U.S. Pat. No. 7,994,401, ADS-18, U.S. Pat. No. 7,964,779, ADS-20 U.S. Ser. No. 13/077,428, ADS-21, U.S. Ser. No. 13/084,314, ADS-22, U.S. Ser. No. 13/206,976 and ADS-24, U.S. Ser. No. 13/219,903), herein incorporated by reference, that the number of limbs present in a stalk of celery varies considerably between different varieties as does the width and thickness of the limbs. The length of the limb to be produced for any particular customer would also have an effect on the number of useable limbs that could potentially be produced from a stalk of celery. For example, if a shorter length celery limb product was desired by the customer more limbs in a stalk are likely to be able to meet the specifications of the product than a longer limb length.

Table 4 shows the variation in the number of limbs that can be generated from different varieties and the variation that exists within varieties with different limb lengths for a 2-dozen count celery size. Column 1 shows the variety, column 2 shows the average number and limb count range, column 3 shows the number of limbs that can be generated from one whole celery stalk for a product with a 6-inch specification, column 4 shows the number of limbs that can be generated from five whole celery stalks for a product with a 6-inch specification, column 5 shows the number of limbs that can be generated from one whole celery stalk for a product with an 8-inch specification, column 6 shows the number of limbs that can be generated from five whole celery stalks for a product with an 8-inch specification column 7 shows the number of limbs that can be generated from one whole celery stalk for a product with a 10-inch specification, column 8 shows the number of limbs that can be generated from five whole celery stalks for a product with a 10-inch specification column 9 shows number of limbs that can be generated from one whole celery stalk for a product with a 12-inch specification, column 10 shows number of limbs that can be generated from five whole celery stalks for a product with a 12-inch specification, column 11 shows number of limbs that can be generated from one whole celery stalk for a product with a 14-inch specification and column 12 shows number of limbs that can be generated from five whole celery stalks for a product with a 14-inch specification.

TABLE 4
Celery Limb Number, Average & Range, for Each Limb Length

| | | 6-inch | | 8-inch | | 10-inch | | 12-inch | | 14-inch | |
|---|---|---|---|---|---|---|---|---|---|---|---|
| | | Single | Five | Single | Five | Single | Five | Single | Five | Single | Five |
| Variety | | Stalk | Stalks | Stalk | Stalks | Stalk | Stalks | Stalk | Stalks | Stalk | Stalks |
| Sonora | Average | 10.2 | 51 | 10.2 | 51 | 9.8 | 49 | 2.5 | 12.5 | 0 | 0 |
| | Range | 8-13 | 40-65 | 8-13 | 40-65 | 7-12 | 35-60 | 0-5 | 0-25 | 0 | |
| Hill's | Average | 11.1 | 55.5 | 11.1 | 55.5 | 10.3 | 51.5 | 8.4 | 42 | 0 | 0 |
| Special | Range | 9-12 | 45-60 | 9-12 | 45-60 | 8-12 | 40-60 | 7-10 | 35-55 | 0 | |
| ADS-2 | Average | 10 | 50 | 9.8 | 49 | 4.8 | 24 | 0 | 0 | 0 | 0 |
| | Range | 9-11 | 45-55 | 8-9 | 40-45 | 2-7 | 10-35 | 0 | 0 | 0 | 0 |
| ADS-8 | Average | 12.7 | 63.5 | 10.6 | 53 | 3.9 | 19.5 | 0 | 0 | 0 | 0 |
| | Range | 11-14 | 55-70 | 9-11 | 45-55 | 1-10 | 5-50 | 0 | 0 | 0 | 0 |
| ADS-12 | Average | 11.2 | 56 | 11.2 | 56 | 11.2 | 56 | 10.3 | 51.5 | 4.7 | 23.5 |
| | Range | 9-14 | 45-70 | 9-14 | 45-70 | 9-14 | 45-70 | 7-14 | 35-70 | 1-8 | 5-40 |
| ADS-5 | Average | 9.3 | 46.5 | 9.3 | 46.5 | 9.0 | 45 | 7.0 | 0.5 | 2.2 | 11 |
| | Range | 7-12 | 35-60 | 7-12 | 35-60 | 6-12 | 35-60 | 5-9 | 25-45 | 0-6 | 0-30 |
| ADS-16 | Average | 10.7 | 53.5 | 10.7 | 53.5 | 10.7 | 53.5 | 10.7 | 53.5 | 8.7 | 43.5 |
| | Range | 7-14 | 35-70 | 7-14 | 35-70 | 7-14 | 35-70 | 7-14 | 35-70 | 6-12 | 30-60 |
| ADS-4 | Average | 12.5 | 62.5 | 12.5 | 62.5 | 12.5 | 62.5 | 11.0 | 55 | 9.6 | 48 |
| | Range | 9-13 | 45-65 | 9-13 | 45-65 | 9-13 | 45-65 | 9-13 | 45-65 | 9-11 | 45-55 |
| ADS-11 | Average | 9.3 | 46.5 | 9.3 | 46.5 | 9.3 | 46.5 | 9.3 | 46.5 | 9.0 | 45 |
| | Range | 8-12 | 40-60 | 8-12 | 40-60 | 8-12 | 40-60 | 8-12 | 40-60 | 8-11 | 40-55 |
| ADS-13 | Average | 10 | 50 | 10 | 50 | 10 | 50 | 10 | 50 | 5.5 | 27.5 |
| | Range | 9-11 | 45-55 | 9-11 | 45-55 | 9-11 | 45-55 | 9-11 | 45-55 | 2-7 | 10-35 |
| ADS-17 | Average | 11.2 | 56 | 11.2 | 56 | 11.2 | 56 | 11.2 | 56 | 11.2 | 56 |
| | Range | 9-14 | 45-70 | 9-14 | 45-70 | 9-14 | 45-70 | 9-14 | 45-70 | 9-14 | 45-70 |
| ADS-18 | Average | 8.9 | 44.5 | 8.9 | 44.5 | 8.9 | 44.5 | 8.9 | 44.5 | 8.9 | 44.5 |
| | Range | 7-12 | 35-60 | 7-12 | 35-60 | 7-12 | 35-60 | 7-12 | 35-60 | 7-12 | 35-60 |

### Example 4

### Number of Limbs Generated by the Method of the Present Invention

Table 5 shows the average number of limbs and the range using the method of the present invention generated from celery variety ADS-2 (U.S. Pat. No. 7,365,248) from a 2-dozen count stalk, a 3-dozen count stalk, and from a heart stalk. Column 1 shows the size carton, column 2 shows the average number of limbs and the range, column 3 shows average number of limbs and the range that can be generated from one whole celery stalk for a product with a 6-inch specification, column 4 shows average number of limbs and the range that can be generated from five whole celery stalks for a product with a 6-inch specification, column 5 shows average number of limbs and the range that can be generated from one whole celery stalk for a product with a 8-inch specification, column 6 shows average number of limbs and the range that can be generated from five whole celery stalks for a product with a 8-inch specification, column 7 shows average number of limbs and the range that can be generated from one whole celery stalk for a product with a 10-inch specification, column 8 shows average number of limbs and the range that can be generated from five whole celery stalks for a product with a 10-inch specification, column 9 shows the average number of limbs and the range that can be generated from one whole celery stalk for a product with an 12-inch specification, column 10 shows the average number of limbs and the range that can be generated from five whole celery stalks for a product with a 12-inch specification, column 11 shows the average number of limbs and the range that can be generated from one whole celery stalk for a product with a 14-inch specification, and column 12 shows the average number of limbs and the range that can be generated from five whole celery stalks for a product with a 14-inch specification.

TABLE 5
Celery Limb Number, Average & Range, for Each Limb Length
ADS-2

| | | 6-inch | | 8-inch | | 10-inch | | 12-inch | | 14-inch | |
|---|---|---|---|---|---|---|---|---|---|---|---|
| | | Single | Five | Single | Five | Single | Five | Single | Five | Single | Five |
| | | Stalk | Stalks | Stalk | Stalks | Stalk | Stalks | Stalk | Stalks | Stalk | Stalks |
| 2-Dozen | Average | 10 | 50 | 9.8 | 49 | 4.8 | 24 | 0 | 0 | 0 | 0 |
| Count | Range | 9-11 | 45-55 | 8-9 | 40-45 | 2-7 | 10-35 | 0 | 0 | 0 | 0 |
| 3-Dozen | Average | 7.6 | 38 | 6.6 | 33 | 3.8 | 19 | 0 | 0 | 0 | 0 |
| Count | Range | 7-9 | 35-45 | 5-7 | 25-35 | 2-5 | 10-25 | 0 | 0 | 0 | 0 |
| Hearts | Average | 5.4 | 27 | 4.6 | 23 | 0 | 0 | 0 | 0 | 0 | 0 |
| | Range | 5-6 | 25-30 | 4-5 | 20-25 | 0 | 0 | 0 | 0 | 0 | 0 |

### Example 5

### Number of Limbs Generated by the Method of the Present Invention

Table 6 shows the average number of limbs and the range using the method of the present invention generated from celery variety ADS-8 (U.S. Pat. No. 6,812,385) from a 2-dozen count stalk, a 3-dozen count stalk, and from a heart stalk. Column 1 shows the size carton, column 2 shows the average number of limbs and the range, column 3 shows average number of limbs and the range that can be generated from one whole celery stalk for a product with a 6-inch specification, column 4 shows average number of limbs and the range that can be generated from one whole celery stalk from five whole celery stalks for a product with a 6-inch specification, column 5 shows average number of limbs and the range that can be generated from one whole celery stalk for a product with a 8-inch specification, column 6 shows average number of limbs and the range that can be generated from one whole celery stalk for a product with a 8-inch specification column 7 shows the average number of limbs and the range that can be generated from one whole celery stalk for a product with an 10-inch specification, and column 8 shows the average number of limbs and the range that can be generated from five whole celery stalks for a product with a 10-inch specification.

TABLE 6
Celery Limb Number, Average & Range, for Each Limb Length
ADS-8

| | | 6-inch | | 8-inch | | 10-inch | |
|---|---|---|---|---|---|---|---|
| | | Single | Five | Single | Five | Single | Five |
| | | Stalk | Stalks | Stalk | Stalks | Stalk | Stalks |
| 2-Dozen | Average | 12.7 | 63.5 | 10.6 | 53 | 3.9 | 19.5 |
| Count | Range | 11-14 | 55-70 | 11-14 | 55-70 | 11-14 | 55-70 |
| 3-Dozen | Average | 9 | 45 | 6.8 | 34 | 0.3 | 1.5 |
| Count | Range | 8-10 | 40-50 | 4-9 | 20-45 | 0-2 | 0-10 |
| Hearts | Average | 6.6 | 33 | 5.8 | 29 | 0 | 0 |

### Example 6

### Number of Limbs Generated by the Method of the Present Invention

Table 7 shows the average number of limbs and the range using the method of the present invention generated from celery variety Hill's Special (PVP Certificate No. 9500019) from a one and one-half-dozen count stalk, a 2-dozen count stalk, a 3-dozen count stalk, and from a heart stalk. Column 1 shows the size carton, column 2 shows the average number of limbs and the range, column 3 shows average number of limbs and the range that can be generated from one whole celery stalk for a product with a 6-inch specification, column 4 shows average number of limbs and the range that can be generated from five whole celery stalks for a product with a 6-inch specification, column 5 shows average number of limbs and the range that can be generated from one whole celery stalk for a product with a 8-inch specification, column 6 shows average number of limbs and the range that can be generated from five whole celery stalks for a product with a 8-inch specification, column 7 shows average number of limbs and the range that can be generated from one whole celery stalk for a product with a 10-inch specification, column 8 shows average number of limbs and the range that can be generated from five whole celery stalks for a product with a 10-inch specification, column 9 shows the average number of limbs and the range that can be generated from one whole celery stalk for a product with an 12-inch specification, and column 10 shows the average number of limbs and the range that can be generated from five whole celery stalks for a product with a 12-inch specification.

TABLE 7
Celery Limb Number, Average & Range, for Each Limb Length
HILL'S SPECIAL

| | | 6-inch | | 8-inch | | 10-inch | | 12-inch | |
|---|---|---|---|---|---|---|---|---|---|
| | | Single | Five | Single | Five | Single | Five | Single | Five |
| | | Stalk | Stalks | Stalk | Stalks | Stalk | Stalks | Stalk | Stalks |
| 1.5-Dozen | Average | 12.6 | 63 | 12.2 | 61 | 10.9 | 54.5 | 7.4 | 37 |
| Count | Range | 11-14 | 55-70 | 11-13 | 55-65 | 10-12 | 50-60 | 5-10 | 25-50 |
| 2-Dozen | Average | 11.1 | 55.5 | 11.1 | 55.5 | 10.3 | 51.5 | 8.4 | 42 |
| Count | Range | 9-12 | 45-60 | 9-12 | 45-60 | 8-12 | 40-60 | 7-10 | 35-50 |
| 3-Dozen | Average | 9.7 | 48.5 | 9.4 | 47 | 8.3 | 41.5 | 6.6 | 33 |
| Count | Range | 8-12 | 40-60 | 8-12 | 40-60 | 8-10 | 40-50 | 4-9 | 20-45 |
| Hearts | Average | 7.3 | 36.5 | 6.5 | 32.5 | 0 | 0 | 0 | 0 |
| | Range | 6-9 | 30-45 | 6-8 | 30-40 | 0 | 0 | 0 | 0 |

### Example 7

### Number of Limbs Generated by the Method of the Present Invention

Table 8 shows the average number of limbs and the range using the method of the present invention generated from celery variety ADS-13 (U.S. Pat. No. 7,435,882) from a 2-dozen count stalk, a 3-dozen count stalk and from a heart stalk. Column 1 shows the size carton, column 2 shows the average number of limbs and the range, column 3 shows average number of limbs and the range that can be generated from one whole celery stalk for a product with a 6-inch specification, column 4 shows average number of limbs and the range that can be generated from five whole celery stalks for a product with a 6-inch specification, column 5 shows average number of limbs and the range that can be generated from one whole celery stalk for a product with a 8-inch specification, column 6 shows average number of limbs and the range that can be generated from five whole celery stalks for a product with a 8-inch specification, column 7 shows average number of limbs and the range that can be generated from one whole celery stalk for a product with a 10-inch specification, column 8 shows average number of limbs and the range that can be generated from five whole celery stalks for a product with a 10-inch specification, column 9 shows the average number of limbs and the range that can be generated from one whole celery stalk for a product with an 12-inch specification, column 10 shows the average number of limbs and the range that can be generated from five whole celery stalks for a product with a 12-inch specification, column 11 shows the average number of limbs and the range that can be generated from one whole celery stalk for a product with a 14-inch specification, and column 12 shows the average number of limbs and the range that can be generated from five whole celery stalks for a product with a 14-inch specification.

TABLE 8
Celery Limb Number, Average & Range, for Each Limb Length
ADS-13

| | | 6-inch | | 8-inch | | 10-inch | | 12-inch | | 14-inch | |
|---|---|---|---|---|---|---|---|---|---|---|---|
| | | Single | Five | Single | Five | Single | Five | Single | Five | Single | Five |
| | | Stalk | Stalks | Stalk | Stalks | Stalk | Stalks | Stalk | Stalks | Stalk | Stalks |
| 2-Dozen | Average | 10.2 | 51 | 10.7 | 53.5 | 10.3 | 51.5 | 9.5 | 47.5 | 5.5 | 27.5 |
| Count | Range | 9-11 | 45-55 | 9-11 | 45-55 | 9-11 | 45-55 | 7-11 | 35-55 | 2-7 | 10-35 |
| 3-Dozen | Average | 7.3 | 36.5 | 7.6 | 38 | 7.2 | 36 | 7.4 | 37 | 6.2 | 31 |
| Count | Range | 6-8 | 30-40 | 6-8 | 30-40 | 6-8 | 30-40 | 6-8 | 30-40 | 4-8 | 20-40 |
| Hearts | Average | 7.1 | 35.5 | 7.2 | 36 | 0 | 0 | 0 | 0 | 0 | 0 |
| | Range | 6-8 | 30-40 | 6-8 | 30-40 | 0 | 0 | 0 | 0 | 0 | 0 |

### Example 8

### Weight of Limbs Generated Using the Method of the Present Invention

Like the number of limbs that are able to be generated from a single stalk or celery heart, the weight of the product that is able to be generated using the method of the present invention may vary.

The current acceptable weight range for a carton of 1.5 to 3 dozen count celery is 55 to 65 pounds. Considering the extremes of that weight range and the number of stalks that may be in the carton, the current average weight for a particular stalk of celery may range from 1.5 to 3.6 pounds.

Currently, packaged celery hearts are sold on a weight basis. They are available as 12-count (packages) per carton at 1.5 pounds per package, or as 18-count (packages) per carton at 1 pound per package. A typical 18-count has two stalks per package with an average stalk weight of 0.5 pound. A typical 12-count has 3 stalks per package with an average stalk weight of 0.5 pound. Regardless of the carton size, the average stalk weight is 0.5 pound. Table 9 shows the range of acceptable average whole stalk weights for different celery products that are currently available.

TABLE 9
Weights of Currently Available Celery Products

| | Pounds per stalk | | |
|---|---|---|---|
| | 12-cnt | 18-cnt | 36-cnt |
| 55-pound box | — | 3.1 | 1.5 |
| 65-pound box | — | 3.6 | 1.8 |
| Heart stalk | 0.5 | 0.5 | — |

Using the method of the present invention, celery stalks representing different varieties in the above size ranges were trimmed to meet the specifications of the present invention and the finished product weighed. The extremes for the finished product weighed from 0.11 pounds to 2.35 pounds from one whole celery stalk and 0.55 pounds to 11.75 pounds from five whole celery stalks as shown in Table 10. The average stalk weight ranged from 0.42 pounds to 1.57 pounds from one whole stalk and 2.1 pounds to 7.85 pounds from five whole celery stalks. Column 1 shows the celery variety, column 2 shows the average weight and the range of weight, column 3 shows the weights for a 6-inch limb from one whole celery stalk, column 4 shows the weights for a 6-inch limb from five whole celery stalks, column 5 shows the weights for an 8-inch limb from one whole celery stalk, column 6 shows the weights for an 8-inch limb from five whole celery stalks, and column 7 shows the weights for a 10-inch limb from one whole celery stalk, column 8 shows the weights for a 10-inch limb from five whole celery stalks, column 9 shows the weights for a 12-inch limb from one whole celery stalk, column 10 shows the weights for a 12-inch limb from five whole celery stalks, column 11 shows the weights for a 14-inch limb from one whole celery stalk, and column 12 shows the weights for a 14-inch single celery stalk from five whole celery stalks.

TABLE 10
Average and Range of Celery Limb Product Weight in Pounds for Stalks of Celery Produced by the Present Invention

| | | 6-inch | | 8-inch | | 10-inch | | 12-inch | | 14-inch | |
|---|---|---|---|---|---|---|---|---|---|---|---|
| | | Single | Five | Single | Five | Single | Five | Single | Five | Single | Five |
| | | Stalk | Stalks | Stalk | Stalks | Stalk | Stalks | Stalk | Stalks | Stalk | Stalks |
| Sonora | Average | 0.99 | 4.95 | 1.26 | 6.3 | 1.4 | 7 | 0.42 | 2.1 | 0 | 0 |
| | Range | 0.65-1.19 | 3.25-5.95 | 0.81-1.54 | 4.05-7.7 | 0.83-1.78 | 4.15-8.9 | 0.0-0.89 | 0-4.45 | 0 | 0 |
| Hill's | Average | 1.09 | 5.45 | 1.37 | 6.85 | 1.55 | 7.75 | 1.35 | 6.75 | 0 | 0 |
| Special | Range | 0.75-1.52 | 3.75-7.6 | 0.93-1.94 | 4.65-9.7 | 0.93-2.16 | 4.65-10.8 | 0.71-1.92 | 3.55-9.6 | 0 | 0 |
| ADS-2 | Average | 0.85 | 4.25 | 1.03 | 5.15 | 0.62 | 3.1 | 0 | 0 | 0 | 0 |
| | Range | 0.71-1.09 | 3.55-5.45 | 0.76-1.19 | 3.8-5.95 | 0.22-0.94 | 1.1-4.7 | 0 | 0 | 0 | 0 |
| ADS-8 | Average | 0.97 | 4.85 | 1.03 | 5.15 | 0.47 | 2.35 | 0 | 0 | 0 | 0 |
| | Range | 0.80-1.09 | 4-5.45 | 0.83-1.21 | 4.15-6.05 | 0.11-1.20 | 0.55-6.0 | 0 | 0 | 0 | 0 |
| ADS-12 | Average | 1 | 5 | 1.26 | 6.3 | 1.49 | 7.45 | 1.57 | 7.85 | 0.9 | 4.5 |
| | Range | 0.87-1.08 | 4.35-5.4 | 1.11-1.49 | 5.55-7.45 | 1.32-1.83 | 6.6-9.15 | 1.23-1.91 | 6.15-9.55 | 0.36-1.66 | 1.8-8.3 |
| ADS-5 | Average | 0.86 | 4.3 | 1.2 | 6 | 1.36 | 6.8 | 1.28 | 6.4 | 0.44 | 2.2 |
| | Range | 0.61-1.24 | 3.05-6.2 | 0.77-1.51 | 3.85-7.55 | 0.86-1.59 | 4.3-7.95 | 0.78-1.68 | 3.9-8.4 | 0-1.45 | 0-7.25 |
| ADS-16 | Average | 0.83 | 4.15 | 1.05 | 5.25 | 1.24 | 6.2 | 1.39 | 6.95 | 1.41 | 7.05 |
| | Range | 0.62-1.03 | 3.1-5.15 | 0.77-1.25 | 3.85-6.25 | 0.92-1.52 | 4.6-7.6 | 0.93-1.70 | 4.65-8.5 | 0.99-1.92 | 4.95-9.6 |
| ADS-3 | Average | 0.89 | 4.45 | 1.11 | 5.55 | 1.36 | 6.8 | 1.29 | 6.45 | 0.8 | 4 |
| | Range | 0.80-1.07 | 4-5.35 | 0.93-1.36 | 4.65-6.8 | 1.06-1.52 | 5.3-7.6 | 1.96-1.52 | 9.8-7.6 | 0.32-1.18 | 1.6-5.9 |
| ADS-4 | Average | 0.74 | 3.7 | 0.93 | 4.65 | 1.12 | 5.6 | 1.23 | 6.15 | 1.25 | 6.25 |
| | Range | 0.58-0.83 | 2.9-4.15 | 0.74-1.02 | 3.7-5.1 | 0.91-1.21 | 4.55-6.05 | 1.04-1.33 | 5.2-6.65 | 1.14-1.46 | 5.7-7.3 |
| ADS-11 | Average | 0.84 | 4.2 | 1.05 | 5.25 | 1.26 | 6.3 | 1.46 | 7.3 | 1.44 | 7.2 |
| | Range | 0.64-1.11 | 3.2-5.55 | 0.78-1.35 | 3.9-6.75 | 0.94-1.62 | 4.7-8.1 | 1.10-1.82 | 5.5-9.1 | 1.23-1.86 | 6.15-9.3 |
| ADS-13 | Average | 0.82 | 4.1 | 1.02 | 5.1 | 1.26 | 6.3 | 1.36 | 6.8 | 0.94 | 4.7 |
| | Range | 0.68-0.96 | 3.4-4.8 | 0.85-1.18 | 4.25-5.9 | 1.07-1.43 | 5.35-7.15 | 1.15-1.57 | 5.75-7.85 | 0.35-1.26 | 1.75-6.3 |
| ADS-17 | Average | 0.75 | 3.75 | 0.97 | 4.85 | 1.2 | 6 | 1.42 | 7.1 | 1.62 | 8.1 |
| | Range | 0.46-1.11 | 2.3-5.55 | 0.64-1.49 | 3.2-7.45 | 0.80-1.79 | 4.0-8.95 | 1.08-2.10 | 5.4-10.5 | 1.21-2.35 | 6.05-11.75 |
| ADS-18 | Average | 0.66 | 3.3 | 0.86 | 4.3 | 1.04 | 5.2 | 1.21 | 6.05 | 1.35 | 6.75 |
| | Range | 0.49-1.04 | 2.45-5.2 | 0.66-1.25 | 3.3-6.25 | 0.80-1.50 | 4.0-7.5 | 0.94-1.73 | 4.7-8.65 | 1.07-2.01 | 5.35-10.05 |

### Example 9

### Weight of Celery Limb Products Generated Using the Method of the Present Invention

Table 11 shows the average weight and range of limbs in pounds of different varieties generated from celery hearts using the method of the present invention. The extremes for the finished product weighed from 0.23 pounds to 0.68 pounds from one whole celery stalk and 1.15 pounds to 3.4 pounds from five whole celery stalks. The average finished product weight ranged from 0.35 pounds to 0.61 pounds from one whole celery stalk and 1.75 pounds to 3.05 pounds from five whole celery stalks. Column 1 shows the celery variety, column 2 shows the average weight and the range of weight, column 3 shows the weights for a 6-inch limb from one whole celery stalk, column 4 shows the weights for a 6-inch limb from five whole celery stalks, column 5 shows the weights for an 8-inch limb from one whole celery stalk, and column 6 shows the weights for an 8-inch limb from five whole celery stalks.

TABLE 11
Celery Limb Product Weight in Pounds, Average and Range,
for Each Limb Length from a Single Stalk or Five Stalks

| | | 6-inch | | 8-inch | |
|---|---|---|---|---|---|
| | | Single | Five | Single | Five |
| Variety | | Stalk | Stalks | Stalk | Stalks |
| Hill's Special | Average | 0.53 | 2.65 | 0.61 | 3.05 |
| | Range | 0.49-0.60 | 2.45-3.0 | 0.55-0.68 | 2.75-3.4 |
| ADS-2 | Average | 0.35 | 1.75 | 0.34 | 1.7 |
| | Range | 0.28-0.42 | 1.4-2.1 | 0.26-0.47 | 1.3-2.35 |
| ADS-3 | Average | 0.4 | 2 | 0.5 | 2.5 |
| | Range | 0.26-0.47 | 1.3-2.35 | 0.34-0.58 | 1.7-2.9 |
| ADS-8 | Average | 0.36 | 1.8 | 0.41 | 2.05 |
| | Range | 0.32-0.39 | 1.6-1.95 | 0.23-0.49 | 1.15-2.45 |
| ADS-13 | Average | 0.41 | 2.05 | 0.51 | 2.55 |
| | Range | 0.39-0.43 | 1.95-2.15 | 0.48-0.53 | 2.4-2.65 |

### Example 10

### Weight of Celery Limb Products Generated Using the Method of the Present Invention

Table 12 shows the average weight and weight range in pounds for various lengths of limbs generated from different stalk sizes, as represented by stalk count per carton, from Hill's Special using the method of the present invention. The extremes for the finished product weighed from 0.49 pounds to 2.16 pounds from one whole celery stalk or 2.45 pounds to 10.8 pounds from five whole celery stalks while the average finished product weighed from 0.53 pounds to 1.90 pounds from one celery stalk and 2.65 pounds to 9.5 pounds from five whole celery stalks. Column 1 shows the size carton, column 2 shows the average number of limbs and the range, column 3 shows the weights for a 6-inch limb from one whole celery stalk, column 4 shows the weights for a 6-inch limb from five whole celery stalks, column 5 shows the weights for an 8-inch limb from one whole celery stalk, column 6 shows the weights for an 8-inch limb from five whole celery stalks, and column 7 shows the weights for a 10-inch limb from on whole celery stalk, column 8 shows the weights for a 10-inch limb from five whole celery stalks, column 9 shows the weights for a 12-inch limb from one whole celery stalk, column 10 shows the weights for a 12-inch limb from five whole celery stalks, column 11 shows the weights for a 14-inch limb from one whole celery stalk, and column 12 shows the weights for a 14-inch limb from five whole celery stalks.

TABLE 12
Celery Limb Product Weight in Pounds, Average and Range, for Each Limb Length
HILL'S SPECIAL

| | | 6-inch | | 8-inch | | 10-inch | | 12-inch | | 14-inch | |
|---|---|---|---|---|---|---|---|---|---|---|---|
| | | Single | Five | Single | Five | Single | Five | Single | Five | Single | Five |
| | | Stalk | Stalks | Stalk | Stalks | Stalk | Stalks | Stalk | Stalks | Stalk | Stalks |
| 1.5-Dozen | Average | 1.31 | 6.55 | 1.64 | 8.2 | 1.9 | 9.5 | 1.4 | 7 | 0 | 0 |
| Count | Range | 1.12-1.52 | 5.6-7.6 | 1.41-1.94 | 7.05-9.7 | 1.54-2.16 | 7.7-10.8 | 0.86-1.92 | 4.3-9.6 | 0 | 0 |
| 2-Dozen | Average | 1.13 | 5.65 | 1.43 | 7.15 | 1.59 | 7.95 | 1.57 | 7.85 | 0 | 0 |
| Count | Range | 1.04-1.30 | 5.2-6.5 | 1.30-1.63 | 6.5-8.15 | 1.46-1.87 | 7.3-9.35 | 1.26-1.76 | 6.3-8.8 | 0 | 0 |
| 3-Dozen | Average | 0.84 | 4.2 | 1.04 | 5.2 | 1.15 | 5.75 | 1.09 | 5.45 | 0 | 0 |
| Count | Range | 0.75-0.93 | 3.75-4.65 | 0.93-1.15 | 4.65-5.75 | 0.93-1.28 | 4.65-6.4 | 0.71-1.28 | 3.55-6.4 | 0 | 0 |
| Hearts | Average | 0.53 | 2.65 | 0.61 | 3.05 | 0 | 0 | 0 | 0 | 0 | 0 |
| | Range | 0.49-0.60 | 2.45-3.0 | 0.55-0.68 | 2.75-3.4 | 0 | 0 | 0 | 0 | 0 | 0 |

### Example 11

### Weight of Limbs Generated Using the Method of the Present Invention

Table 13 shows the average weight and weight range in pounds for various lengths of limbs generated from different stalk sizes, as represented by stalk count per carton, from ADS-2 using the method of the present invention. The extremes for the finished product weighed from 0.22 pounds to 1.19 pounds from one whole celery stalk and 1.1 pounds to 5.95 pounds from five whole celery stalks while the average finished product weighed from 0.35 pounds to 1.03 pounds from a single celery stalk and 1.75 pounds to 5.15 pound from five whole celery stalks. Column 1 shows the size carton, column 2 shows the average number of limbs and the range, column 3 shows the weights for a 6-inch limb from one whole celery stalk, column 4 shows the weights for a 6-inch limb from five whole celery stalks, column 5 shows the weights for an 8-inch limb from one whole celery stalk, column 6 shows the weights for an 8-inch limb from five whole celery stalks, and column 7 shows the weights for a 10-inch single celery stalk, column 8 shows the weights for a 10-inch limb from five whole celery stalks, column 9 shows the weights for a 12-inch limb from one whole celery stalk, column 10 shows the weights for 12-inch limbs from five whole celery stalks, column 11 shows the weights for a 14-inch limb from one whole celery stalk, and column 12 shows the weights for a 14-inch limb from five whole celery stalks.

TABLE 13
Celery Limb Weight in Lbs, Average & Range, for Each Limb Length
ADS-2

| | | 6-inch | | 8-inch | | 10-inch | | 12-inch | | 14-inch | |
|---|---|---|---|---|---|---|---|---|---|---|---|
| | | Single | Five | Single | Five | Single | Five | Single | Five | Single | Five |
| | | Stalk | Stalks | Stalk | Stalks | Stalk | Stalks | Stalk | Stalks | Stalk | Stalks |
| 2-Dozen | Average | 0.85 | 4.25 | 1.03 | 5.15 | 0.62 | 3.1 | 0 | 0 | 0 | 0 |
| | Range | 0.71-1.00 | 3.55-5.0 | 0.76-1.19 | 3.8-5.95 | 0.22-0.94 | 1.1-4.7 | 0 | 0 | 0 | 0 |
| 3-Dozen | Average | 0.59 | 2.95 | 0.7 | 3.5 | 0.49 | 2.45 | 0 | 0 | 0 | 0 |
| | Range | 0.54-0.71 | 2.7-3.55 | 0.58-0.89 | 2.9-4.45 | 0.28-0.66 | 1.4-3.3 | 0 | 0 | 0 | 0 |
| Hearts | Average | 0.35 | 1.75 | 0.39 | 1.95 | 0 | 0 | 0 | 0 | 0 | 0 |
| | Range | 0.28-0.42 | 1.4-2.1 | 0.26-0.47 | 1.3-2.35 | 0 | 0 | 0 | 0 | 0 | 0 |

### Example 12

### Improved Product Quality of the Method of the Present Invention

Trimming a stalk of celery to produce celery limbs of the present invention, which are then marketed to the consumer, is environmentally advantageous as well as practical for the consumer. The removal of the basal plate, the leaves, and the heart produces a celery limb product that is environmentally friendly. By removing the portion of the celery stalk that most consumers do not use there is less energy required for refrigeration, less space taken up for storage and less waste for the consumer. Since the product size of the present invention is reduced, more celery product can be placed in a typical transportation truck reducing the actual transportation cost per stalk equivalent as well as decreasing the fuel required to deliver the product to market.

Another unexpected advantage of the method of the present invention is the improved product quality to the consumer. A celery stalk that is left intact with the celery heart and some leaves attached is still very physiologically active, even when the temperature is kept at 34° F. This can be demonstrated by a stalk of celery being left on its side in a cooler at 34° F. with a low level light overhead. At a temperature of 34° F., the celery leaves will move to the light. In order for the leaves to move toward the light, the celery consumes stored energy reserves. The same response is not observed in a product of the method of the present invention.

The appropriate temperature for storage and transportation of leafy produce to market is 34° F. to 36° F. degrees. In transport, celery is intentionally shipped in dark cartons with an orientation of the long axis of the stalk remaining vertical so that the stalk remains straight for the consumer. In the market, the stalks are displayed horizontally under lights but the product is generally sold before a visible response occurs. However, this does not stop physiological activity. Additionally, even under conditions of refrigeration, a celery stalk containing the growing point, which is a part of the heart and exists at the center of the butt, is still a living organism. When cut or injured a celery stalk begins translocating its nutritional reserves and sugars from the outside limbs to the growing point. While under refrigeration this process is slowed but it does not completely stop. By removing the butt, heart and leaves there is nowhere for these reserves to be translocated and the quality of the preferred portion of the celery stalk for consumption is unexpectedly sweeter.

Surprisingly, this quality advantage of celery limbs of the present invention was confirmed by testing sugars.

Table 14 shows a comparison of the measured percent maximum sweetness of celery limbs of the present invention versus whole celery stalks. Four dozen celery stalks were harvested at day one and celery limbs were prepared from half of the stalks. Levels of four sugars found in celery were then tested (glucose, fructose, sucrose and mannitol). The same tests were performed on additional samples every day for a total of seven days. Each of these sugars has a different sweetness level so each sugar was then converted to a sweetness equivalence value. Sucrose was calculated at 100, fructose 173, glucose 74 and mannitol 70. The total sweetness equivalence value was calculated by adding each sugar for each sample each day of testing. For these samples the peak sweetness value for the celery was found on the second day following harvest in the branches. This value was considered the peak sweetness or 100% of the maximum sweetness for the celery products being tested. Each sample was then compared as a percentage of this maximum sweetness. Column 1 shows celery limbs and whole celery stalks. Columns 2 through column 8 show the percent maximum sweetness of the celery and the number of days after harvest. The sweetness level increased one day following harvest for both whole stalk and celery limbs of the present invention. The sweetness levels remain relatively unchanged for the first three days following harvest. However, the whole stalk celery begins to lose sugars very rapidly four days following harvest. The sweetness of celery limbs remains relatively unchanged through day seven. Celery samples were maintained at 34° F. without light for the duration of the experiment.

TABLE 14
Comparison of Sweetness of Celery Limbs versus Whole
Celery Stalk Measured by Percent of Maximum Sweetness

| | Number of days from harvest | | | | | | |
|---|---|---|---|---|---|---|---|
| | 1 | 2 | 3 | 4 | 5 | 6 | 7 |
| Celery Limbs | 91% | 99% | 100% | 99% | 97% | 97% | 98% |
| Whole Celery Stalk | 91% | 98% | 99% | 99% | 89% | 88% | 86% |

As shown in Table 14, whole celery stalks left intact show a significant decrease in sugar levels or sweetness within five days after harvest compared to the celery limbs of the present invention. By the seventh day, there is only a slight decrease in the sugar levels in the celery limbs of the present invention, while stalk celery continues to lose sugars rapidly.

The data in Tables 3-13 demonstrate that the range of weights for a finished celery limb product of the present invention, regardless of the customer's length specifications, will range from 0.10 pounds for a single celery stalk and up to 11.75 pounds for five celery stalks.

The method of the present invention provides an important replacement for whole stalk celery and embodies the whole stalk minus the less desirable portions of whole stalk celery (i.e. leaf, heart, butt). By eliminating the heart, foliage, basal plate or butt of the plant and, depending on the customer, a portion of the flare, the present invention is an improved product with reduced packaged weight. This provides an unexpected additional advantage of reducing shipment costs, making the celery of the instant invention more environmentally friendly.

By creating a product which includes only the most desirable portion of the celery stalk, the limbs, the product volume is significantly reduced. This is also very beneficial to the consumer because there is less space utilized in the refrigerator for storage. It is also beneficial to the customer because it takes up less space on the produce display in the store and reduces cost. By removing the leaves and the growing point from the celery unexpectedly the quality of this finished product is improved. Even under conditions of refrigeration, a celery stalk containing the growing point, which is a part of the heart and exists at the center of the butt, is still a living organism. When cut or injured a celery stalk begins translocating its nutritional reserves and sugars from the outside limbs to the growing point in order to sustain life. While under refrigeration this process is slowed but it does not cease. By removing the butt, heart and leaves there is nowhere for these reserves to be translocated and the quality of the preferred portion of the celery stalk for consumption is improved.

While a number of exemplary embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A method for producing a semi-processed celery product, said method comprising the steps:
a. preparation of Apium graveolens celery for cutting;
b. cutting said celery into limb lengths between 6 and 18 inches;
c. sanitizing said celery;
d. packaging said celery; and
e. obtaining a semi-processed celery product, wherein steps a.-d. are preformed with good food safety practices throughout.

2. The method of claim 1, wherein said Apium graveolens celery is selected from the group consisting of ADS-2, ADS-3, ADS-4, ADS-5, ADS-7, ADS-8, ADS-11, ADS-12, ADS-13, ADS-16, ADS-17, ADS-18, ADS-19, ADS-20, ADS-21, ADS-22, ADS-23 and ADS-24.

3. The method of claim 1, wherein said preparation of celery for cutting includes removal of the leaves, heart, and butt.

4. The method of claim 1, further comprising the step of applying a thermal stress to said Apium graveolens celery to prevent wound-induced browning.

5. The method of claim 4, wherein the step of applying a thermal stress is performed prior to steps a.-d.

6. The method of claim 4, wherein the step of applying a thermal stress is performed after steps a.-d.

7. The method of claim 4, wherein the step of applying a thermal stress is performed simultaneously with one of steps a.-d.

8. The method of claim 4, wherein the step of applying a thermal stress is performed between two of the steps a.-d.

9. The method of claim 4, wherein said thermal stress is induced by subjecting Apium graveolens celery to a temperature range from about 40° C. to about 70° C. for about 10 to about 480 seconds.

10. The method of claim 4, wherein the thermal stress is applied by immersing the Apium graveolens celery in a liquid.

11. The method of claim 4, wherein the thermal stress is applied by exposing the Apium graveolens celery to air.

12. The method of claim 4, further comprising the step of cooling said Apium graveolens celery after said thermal stress.

13. The method of claim 1, wherein cutting said celery is performed by an object selected from the group consisting of knives, razor sharp blades, saws, water jets, lasers and sound waves.

14. The method of claim 1, wherein said preparation of celery for cutting includes spraying or immersing the celery in water or solution to remove soil, plant debris, or other physical, chemical, or microbiological contaminants from said celery plant.

15. The method of claim 14, wherein said solution is a sanitization treatment or poly ethylene glycol.

16. The method of claim 1, wherein sanitizing said celery is performed by one or more sanitization treatments selected from the group consisting of an oxidizing agent, bromine products, peroxyacetic acid, ozone, a thermal treatment, a non-thermal treatment, trisodium phosphate, quaternary ammonium products, acidifying agents and enzymatic agents.

17. The method of claim 16, wherein said oxidizing agent is selected from the group consisting of chlorine, chlorine gas, sodium hypochlorite, calcium hypochlorite, chlorine dioxide and acidified sodium chlorite.

18. The method of claim 16, wherein said bromine product is sodium hypobromine.

19. The method of claim 16, wherein said thermal treatment comprises steam, ultra heat, or surface pasteurization.

20. The method of claim 19, further comprising the step of cooling said celery.

21. The method of claim 16, wherein said non-thermal treatment comprises ultraviolet light, pressure of about 60,000 PSI to about 100,000 PSI, or irradiation.

22. The method of claim 16, wherein sanitizing said celery is performed by a sanitization treatment is performed in a water or liquid solution from between 0° C. and 60° C. in order to optimize sanitization treatment.

23. The method of claim 16, wherein the step of applying a sanitization treatment is performed prior to steps a., b., or d.

24. The method of claim 16, wherein the step of applying a sanitization treatment is performed after steps a., b., or d.

25. The method of claim 16, wherein the step of applying a sanitization treatment is performed simultaneously with one of steps a., b., or d.

26. The method of claim 16, wherein the step of applying a sanitization treatment is performed at two or more steps before, between or during steps a., b., or d.

27. The method of claim 1, wherein the process of packaging said celery uses a package comprising material selected from the group consisting of flexible film, rigid plastic, solid fiber, poly sleeves, plastic sleeves, poly bags, plastic bags, natural decomposable bags, and natural decomposable sleeves, and wherein said package may be opened and resealed.

28. The method of claim 27, wherein said package further comprises built-in vents or specialized pores.

29. The method of claim 1, wherein the limb length is between 6.00 and 7.99 inches long.

30. The method of claim 1, wherein the limb length is between 8.00 and 9.99 inches long.

31. The method of claim 1, wherein the limb length is between 10.00 and 11.99 inches long.

32. The method of claim 1, wherein the limb length is between 12.00 and 13.99 inches long

33. The method of claim 1, wherein the limb length is between 14.00 and 15.99 inches long.

34. The method of claim 1, wherein the limb length is between 16.00 and 18.00 inches long.

35. A celery product produced by the method of claim 1, wherein said celery product is ready-to-eat or ready-to-use.

36. A celery product produced by the method as in any of claim 1-4, 13, 14, 16, 27, or 35, in which the celery limb product has an increased percent maximum sweetness of between 1% and 14% five to seven days after harvest compared to a whole stalk, wherein said celery limb product and said whole celery stalk are harvested on the same day.

37. A celery product produced by the method of claim 1, wherein the weight of the final celery limb product is from about 0.10 to about 11.75 pounds.

38. A celery product produced by the method of claim 1, wherein the final celery limb product consists essentially of 1 to 70 limbs.
